(19) United States
(12) Patent Application Publication
(10) Pub. No.: US 2019/0346929 A1
(43) Pub. Date: Nov. 14, 2019

(54) Attention Levels in a Gesture Control System

(71) Applicant: Piccolo Labs Inc., San Francisco, CA (US)

(72) Inventors: Marlon Misra, San Francisco, CA (US); Neil Raina, San Francisco, CA (US)

(73) Assignee: Piccolo Labs Inc., San Francisco, CA (US)

(21) Appl. No.: 15/978,028

(22) Filed: May 11, 2018

(51) Int. Cl. G06F 3/01; G06K 9/00; G06F 3/16; H04L 12/28

(52) U.S. Cl. CPC G06F 3/017; H04L 12/282; G06F 3/167; G06K 9/00355

(57) ABSTRACT

A gesture control system is provided having multiple attention levels. The gesture control system monitors for events based on the current attention level that it is in, while being free to ignore events at other attention levels. In an initial attention level, the gesture control system may monitor for an event to cause it to transition to an active state comprising a second attention level. In the second attention level, the gesture control system may monitor for a user gesture to perform an action on an electronic device. Upon detecting the user gesture, the gesture control system may transition to a third attention level where it monitors for a voice command or other input that modifies the meaning of the user gesture. The gesture control system may then perform an action based on the user gesture and the voice command or other input.

### CROSS-REFERENCE TO RELATED APPLICATIONS

Not applicable.

### FIELD OF THE INVENTION

The present invention relates to a gesture control system including one or more attention levels.

### BACKGROUND

Current gesture control systems have no concept of an attention level. Once current gesture control systems are in an active state, they try to detect and recognize all the gestures in their vocabulary of recognizable gestures. This limits the number of gestures that can be in the gesture vocabulary of the gesture control system because of the performance constraints of trying to recognize a large number of gestures, some of which may be similar, and can lead to false detections between gestures that have similar motions. Moreover, there are particular challenges for a gesture control system that is always active, such as a home control system, because people may perform certain motions during normal activity that are similar to gestures in the gesture vocabulary and thereby inadvertently activate the gesture control system.

An additional limitation of current gesture control systems is a lack of integration with voice control, so that gesture and voice can be used together to control computer devices. Current systems tend to use gesture or voice as either-or methods of control rather than, for example, having a voice command supplement a gesture, or vice versa.

It would be desirable to provide a gesture control system that could detect certain gestures at certain times, rather than all the time. A novel approach described herein is a system of attention levels where the gesture control system may attend to different events at different times. Another novel approach described herein is attention levels that can involve non-gesture inputs like voice or sounds, so that voice commands may supplement gestures to allow for a greater range of controls.

### SUMMARY OF THE INVENTION

One embodiment relates to a method and system for gesture control having a plurality of attention levels. The attention levels may have attention level events. The gesture control system may monitor for attention level events when it is in the associated attention level and ignore events of other attention levels. The gesture control system may include one or more cameras and a processor for gesture recognition. The gesture control system may also include a microphone and speech recognition processing to respond to voice commands.

One embodiment relates to a method for detecting gestures in a gesture control system. The gesture control system may be initialized in a first attention level out of three attention levels. While in the first attention level, the gesture control system may monitor for first attention level events and ignore second attention level events and third attention level events. The gesture control system may detect a first attention level trigger event and transition to the second attention level. While in the second attention level, the gesture control system may monitor for second attention level events and ignore first attention level events and third attention level events. The gesture control system may detect a second attention level trigger event and transition to a third attention level. While in the third attention level, the gesture control system may monitor for third attention level events and ignore first attention level events and second attention level events. The gesture control system may detect a third attention level event and determine an action to perform. It may transmit a signal to an electronic device to perform an action. Gesture control systems herein may also have more or fewer attention levels and are not limited to three levels.

### BRIEF DESCRIPTION OF THE DRAWINGS

FIG. 1 illustrates an exemplary network environment in which embodiments may operate.

FIG. 2 illustrates an exemplary hardware sensor device that may be used in some embodiments.

FIG. 3 illustrates the exemplary operation of a gesture control system embodiment.

FIG. 4 illustrates an exemplary sequence of events.

FIG. 5 illustrates an exemplary method that may be performed in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Embodiments of the invention may comprise one or more computers. Embodiments of the invention may comprise software and/or hardware. Some embodiments of the invention may be software only and may reside on hardware. A computer may be special-purpose or general purpose. A computer or computer system includes without limitation electronic devices performing computations on a processor or CPU, personal computers, desktop computers, laptop computers, mobile devices, cellular phones, smart phones, PDAs, pagers, multi-processor-based devices, microprocessor-based devices, programmable consumer electronics, cloud computers, tablets, minicomputers, mainframe computers, server computers, microcontroller-based devices, DSP-based devices, embedded computers, wearable computers, electronic glasses, computerized watches, and the like. A computer or computer system further includes distributed systems, which are systems of multiple computers (of any of the aforementioned kinds) that interact with each other, possibly over a network. Distributed systems may include clusters, grids, shared memory systems, message passing systems, and so forth. Thus, embodiments of the invention may be practiced in distributed environments involving local and remote computer systems. In a distributed system, aspects of the invention may reside on multiple computer systems.

Embodiments of the invention may comprise computer-readable media having computer-executable instructions or data stored thereon. A computer-readable media is physical media that can be accessed by a computer. It may be non-transitory. Examples of computer-readable media include, but are not limited to, RAM, ROM, hard disks, flash memory, DVDs, CDs, magnetic tape, and floppy disks.

Computer-executable instructions comprise, for example, instructions which cause a computer to perform a function or group of functions. Some instructions may include data. Computer executable instructions may be binaries, object code, intermediate format instructions such as assembly language, source code, byte code, scripts, and the like. Instructions may be stored in memory, where they may be accessed by a processor. A computer program is software that comprises multiple computer executable instructions.

A database is a collection of data and/or computer hardware used to store a collection of data. It includes databases, networks of databases, and other kinds of file storage, such as file systems. No particular kind of database must be used. The term database encompasses many kinds of databases such as hierarchical databases, relational databases, post-relational databases, object databases, graph databases, flat files, spreadsheets, tables, trees, and any other kind of database, collection of data, or storage for a collection of data.

A network comprises one or more data links that enable the transport of electronic data. Networks can connect computer systems. The term network includes local area network (LAN), wide area network (WAN), telephone networks, wireless networks, intranets, the Internet, and combinations of networks.

In this patent, the term “transmit” includes indirect as well as direct transmission. A computer X may transmit a message to computer Y through a network pathway including computer Z. Similarly, the term “send” includes indirect as well as direct sending. A computer X may send a message to computer Y through a network pathway including computer Z. Furthermore, the term “receive” includes receiving indirectly (e.g., through another party) as well as directly. A computer X may receive a message from computer Y through a network pathway including computer Z.

Similarly, the terms “connected to” and “coupled to” include indirect connection and indirect coupling in addition to direct connection and direct coupling. These terms include connection or coupling through a network pathway where the network pathway includes multiple elements.

To perform an action “based on” certain data or to make a decision “based on” certain data does not preclude that the action or decision may also be based on additional data as well. For example, a computer performs an action or makes a decision “based on” X, when the computer takes into account X in its action or decision, but the action or decision can also be based on Y.

In this patent, “computer program” means one or more computer programs. A person having ordinary skill in the art would recognize that single programs could be rewritten as multiple computer programs. Also, in this patent, “computer programs” should be interpreted to also include a single computer program. A person having ordinary skill in the art would recognize that multiple computer programs could be rewritten as a single computer program.

The term computer includes one or more computers. The term computer system includes one or more computer systems. The term computer server includes one or more computer servers. The term computer-readable medium includes one or more computer-readable media. The term database includes one or more databases.

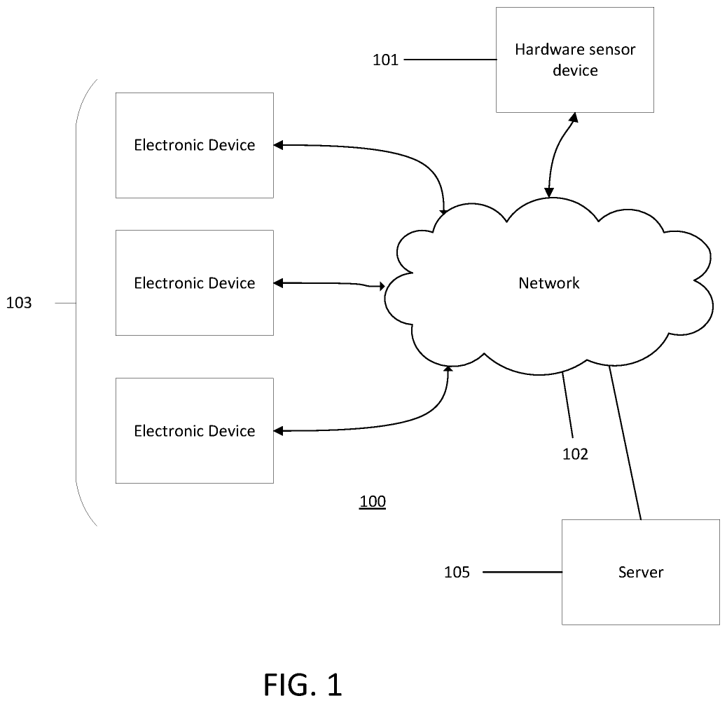

FIG. 1 illustrates an exemplary network environment 100 in which the methods and systems herein may operate. Hardware sensor device 101 may collect sensor data such as video and audio data. The hardware sensor device 101 may be connected to network 102. The network 102 may be, for example, a local network, intranet, wide-area network, Internet, wireless network, wired network, Wi-Fi, Bluetooth, or other networks. Electronic devices 103 connected to the network 102 may be controlled according to gestures captured and detected in video by the hardware sensor device 101 or by voice commands detected by a microphone in the hardware sensor device 101. Gestures may be detected by processes performed on the hardware sensor device 101 or on other computer systems like optional server 105. Audio, such as audio voice recordings, may be detected and recognized using speech recognition processes performed on the hardware sensor device 101 or on other computer systems like optional server 105.

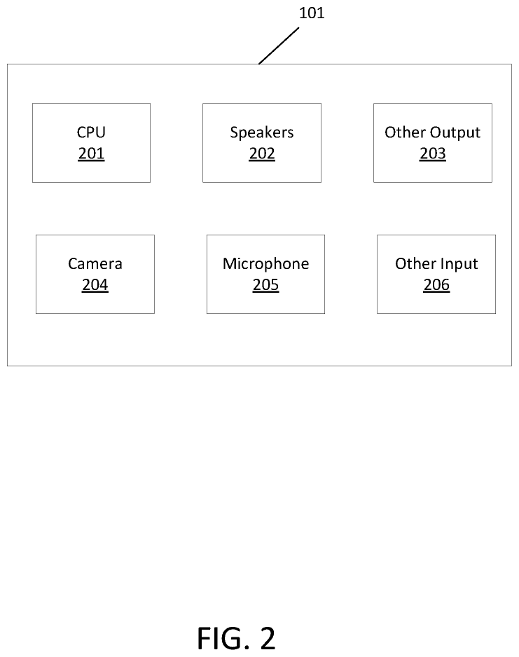

FIG. 2 illustrates an exemplary hardware sensor device 101. The exemplary hardware sensor device 101 may have a CPU 201 and input sensors such as a camera 204, microphone 205, and other input sensors 206. The camera 204 may be a digital video camera or still digital camera capable of capturing digital images using a pixel array. Optionally, the camera 204 may be stereoscopic, or two or more cameras may be used. The microphone 205 may detect audio data from the environment. Other input sensors 206 may include, for example, a depth sensor. The exemplary hardware sensor device 101 may have output devices such as speakers 202 for playing audio and other output sensors 203.

The hardware sensor device 101 may comprise a gesture control system. A gesture control system enables control of computer devices through user gestures. Optionally, a remote server 105 may also comprise part of the gesture control system. Processing to recognize gestures may be performed on the CPU 201 in the hardware sensor device 101 or on the remote server 105.

In an exemplary method of gesture control, the hardware sensor device 101 may capture video using the camera 204 and store the video file in memory. The video file may comprise one or more frames. If the video is to be processed by the hardware sensor device 101, then the video file may be processed by the CPU 201. Alternatively, the hardware sensor device 101 may transmit the file to a remote server 105 over network 102. The hardware sensor device 101 or other processor may optionally crop the image frame around motion in the image frame to capture just the portion of the image frame including a user. Then the hardware sensor device 101 or other processor may perform a full body pose estimation on the image frame to determine the full body pose of the user. The return value of the full body pose estimation may be a skeleton comprising one or more body part keypoints that represent locations of body parts. The body part keypoints may represent key parts of the body that help determine a pose.

After the body pose estimation, localized models for specific body parts may be applied to determine the state of specific body parts. An arm location model may be applied to one or more body part keypoints to predict a direction in which a user is pointing. The arm location model may be a machine learning model that accepts body part keypoints as input and returns a predicted state of the arm or one or more gestures. The arm location model may return a set of predicted states or gestures with associated confidence values indicating the probability that the state or gesture is present.

After the arm location model is applied, the sub-portion of the image frame including the user's hands may be identified by locating body keypoints near the hands. Hand pose estimation may be performed to determine the coordinates of one or more hand keypoints from the sub-portion of the image frame including the user's hands. A hand gesture model may then be applied to the one or more hand keypoints to predict the state of the hand of the user. A hand gesture model may be a machine learning model that accepts hand keypoints as inputs and returns a predicted state of the hand or hand gesture. The hand gesture model may return a set of predicted hand states or hand gestures with associated confidence values indicating the probability that the state or gesture is present.

The gesture control system may determine a gesture being performed by the user based on the body pose, arm location, and hand gesture determined by the system. A gesture may comprise aspects of the full body pose, arm location, and hand gesture.

In one embodiment, the gesture control system is installed in a home or office to allow control of devices in the environment. The camera 204 of the hardware sensor device is directed towards the environment to capture images of user activity. The gesture control system may remain continually in an “on” mode 24-hours a day to allow users to control devices in the environment at any time of day.

In some embodiments, the gesture control system may allow users to control devices in the environment by pointing at them. For example, the gesture control system may determine coordinates that the user is pointing at with an arm, hand, finger, or other body part. The gesture control system may perform a look up of a data structure, such as a database or table, that stores coordinates of electronic devices in the room or scene. The gesture control system may compare the coordinates of the electronic devices in the data structure with the coordinates that the user is indicating, such as by pointing, to find the nearest electronic device to the indicated coordinates. The gesture control system may then transmit a signal to control said electronic device. In other words, the gesture control system may control electronic devices in a room or scene according to the indications of a user, such as by pointing or other gestures.

Electronic devices that may be controlled by these processes may include lamps, fans, televisions, speakers, personal computers, cell phones, mobile devices, tablets, computerized devices, appliances, and many other kinds of electronic devices. In response to gesture control, a computer system may direct these devices, such as by transmitting a signal to turn on, turn off, increase volume, decrease volume, change channels, change brightness, visit a website, play, stop, fast forward, rewind, and other operations of the devices.

The gesture control system, comprising hardware sensor device 101 and/or remote server 105, may also include speech recognition from audio data to allow control of devices from voice commands. Audio files comprising voice data may be collected by microphone 205 on the hardware sensor device 101. The gesture control system may perform speech recognition on the audio files to determine the content of the utterances by the user. In some embodiments, this may be performed by first transcribing the audio file to text using an automatic speech recognition system and then using a machine learning model to classify the text into a predicted type of command. In other embodiments, the audio file may be classified by a machine learning model into a predicted type of command without first being transcribed to text. In either case, supervised or unsupervised learning may be used.

In some embodiments, the gesture control system allows control of electronic devices in the environment through voice commands that identify the name of the device and an action to perform. For example, a command such as “Turn on the light” identifies an action and a device to perform the action upon. A machine learning model in the gesture control system may identify the action in a voice command and identify the target device in the voice command. The gesture control system may then transmit a signal to the target device to perform the action.

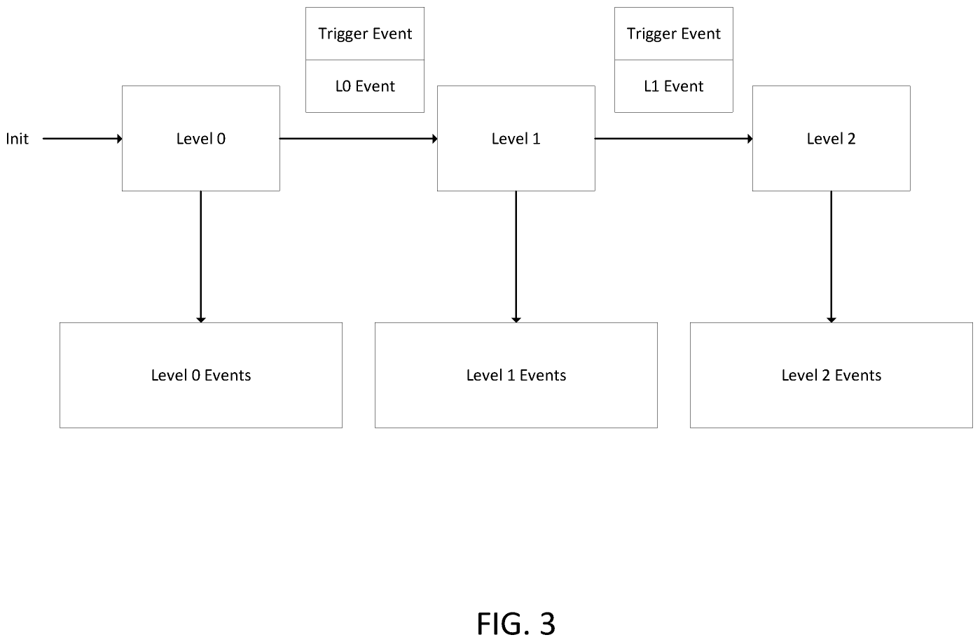

FIG. 3 illustrates the exemplary operation of an embodiment of a gesture control system with multiple attention levels. The gesture control system is illustrated with three attention levels, but more or fewer attention levels may be used. Each attention level is associated with attention level events that are only recognized when the gesture control system is in the associated attention level. When the gesture control system is in attention level 0, the gesture control system only monitors for attention level 0 events, when the gesture control system is in attention level 1, the gesture control system only monitors for attention level 1 events, and when the gesture control system is in attention level 2, the gesture control system only monitors for attention level 2 events. Events at each attention level may be gestures, voice commands, or other inputs from a user. Events may be detected by camera 204, microphone 205, and other inputs 206 such as depth sensors, stereoscopic cameras, and so on. In response to detection of an event, the gesture control system may perform an action on an electronic device.

A trigger event may be detected by the gesture control system to transition the gesture control system from one attention level to another. Trigger events may be used to transition to higher attention levels or to lower attention levels. Moreover, trigger events may indicate not just transitioning from one attention level to another, but may also include event content. Event content may comprise information about the content of an action to be performed.

Higher attention level events may therefore also include content from the chain of earlier attention level trigger events that led to the higher attention level. For example, an attention level 0 event may include just the content from the attention level 0 event. An attention level 1 event may include content from the attention level 0 event that triggered the transition to attention level 1 and the attention level 1 event. An attention level 2 event may include content from the attention level 0 event that triggered the transition to attention level 1 and the attention level 1 event that triggered the transition to attention level 2 and the attention level 2 event.

The gesture control system may determine an action to perform based on the trigger events at earlier attention levels combined with the event detected at the current attention level. For a level 1 event, the gesture control system may identify and evaluate the content of the attention level 0 trigger event that caused the transition to attention level 1 in combination with the attention level 1 event to determine an action to perform. For a level 2 event, the gesture control system may identify and evaluate the content of the attention level 1 trigger event that caused the transition to attention level 2 in combination with the attention level 0 event that caused the transition to level 1 and the attention level 2 event to determine an action to perform.

In an embodiment, attention level 0 is used only for detecting a trigger event that activates the gesture control system. In this embodiment, no other events other than a trigger event from attention level 0 to attention level 1 is detected in attention level 0. This feature helps eliminate false detections when users are performing routine actions and are not intending to perform actions for the gesture control system because attention level 1 events and attention level 2 events are not monitored or detected. A level 0 trigger event may be, for example, a user raising their arm. Other gestures may also be used as trigger events. Upon detection of this trigger event, the gesture control system may transition to attention level 1 where it may monitor and detect attention level 1 events.

Other types of inputs other than gestures may also be used to as trigger events to activate the gesture control system out of attention level 0. For example, a voice command such as “on” or “attention” may be used as a trigger event. Other inputs such as clapping may also be used as a trigger event.

In an embodiment, in attention level 1, the gesture control system monitors for and detects gestures of users for controlling devices. For example, a user may point at a lamp to turn it on or off or perform a gesture towards a television to change the channel. Optionally, attention level 1 lasts for only a few seconds, such as 1 second, 2 seconds, 3 seconds, 4 seconds, 5 seconds, 6 seconds, 7 seconds, 8 seconds, 9 seconds, 10 seconds, 1-3 seconds, 3-5 seconds, 5-7 seconds, 7-9 seconds, or so on. When the gesture control system transitions to attention level 1 after a trigger event in attention level 0, it sets a timer for a set period of time to remain in attention level 1. If no attention level 1 event is detected by the gesture control system before the expiration of the timer, then the gesture control system transitions back to attention level 0. This features helps eliminate false positives by transitioning quickly back to attention level 0 where no events other than a trigger event are detected.

The current attention level of the gesture control system may be indicated by a user interface element. Attention level 1 may be indicated by turning on a light on the hardware sensor device 101, such as a light mounted on the camera 204 of the hardware sensor device 101. Attention level 1 may also be indicated by a sound that is emitted from speakers 202 when attention level 1 is reached. Other indicators may also be used to indicate that attention level 1 has been reached, such as display of an indication on a computer screen, tactile feedback, and other mechanisms.

The gesture control system may also include cancellation gestures for attention level 1. In some embodiments, the cancellation gesture may be the same as the trigger gesture for entering attention level 1. In response to detecting a cancellation gesture, the gesture control system may transition from attention level 1 to attention level 0.

The gesture control system may transition from attention level 1 to attention level 2 in response to receiving a trigger event.

In an embodiment, attention level 2 events add further context to an attention level 1 event. The gesture control system may use the information about the level 2 event to modify the action taken in response to the attention level 1 event.

For example, in attention level 1, the gesture control system may detect the user pointing to a device. The user gesture of pointing to a device is both a trigger event to transition to attention level 2 and also contains event content by identifying which device should be acted upon. Now in attention level 2, the gesture control system may detect a user voice command such as “turn it on.” The gesture control system identifies the level 1 trigger event of pointing at the device and the attention level 2 event comprising the voice command of “turn it on” and combines the information from these events to determine that the appropriate action is to turn on the target device. The gesture control system then transmits a signal to the target device to turn it on. After the gesture control system has detected the attention level 2 event, it may automatically transition back to attention level 0 or transition back to attention level 1.

Optionally, attention level 2 lasts for only a few seconds, such as 1 second, 2 seconds, 3 seconds, 4 seconds, 5 seconds, 6 seconds, 7 seconds, 8 seconds, 9 seconds, 10 seconds, 1-3 seconds, 3-5 seconds, 5-7 seconds, 7-9 seconds, or so on. When the gesture control system transitions to attention level 2 after a trigger event in attention level 1, it may set a timer for a set period of time to remain in attention level 2. If no attention level 2 event is detected by the gesture control system before the expiration of the timer, then the gesture control system transitions back to attention level 0 or to attention level 1.

Some attention level 1 events may have no associated attention level 2 events that can modify them. For example, some attention level 1 events may have no further context that needs to be added.

When multiple users are in an environment, the gesture control system may track and store an attention level per user. Different users may be at different attention levels. The gesture control system may detect that a first user has performed an attention level 0 trigger event to transition to attention level 1. Meanwhile, a second user may have performed an attention level 0 trigger event and attention level 1 trigger event and be in attention level 2. A third user may have performed no actions and still be in attention level 0. The gesture control system detects events of each user according to the attention level that the particular user is in.

Alternatively, the gesture control system may maintain a single global attention level for all users in an environment. If a first user performs a trigger event to cause the gesture control system to enter attention level 1, then the gesture control system enters attention level one for all users and a second user may perform an attention level 1 event that is detected by the gesture control system.

In some embodiments, attention level 0 is not used and the gesture control system has only a 2 level attention system with level 1 and level 2. The gesture control system is initialized in attention level 1 where it monitors for and detects user gestures to control devices. As described above, attention level 2 events may be used to add context to the attention level 1 events.

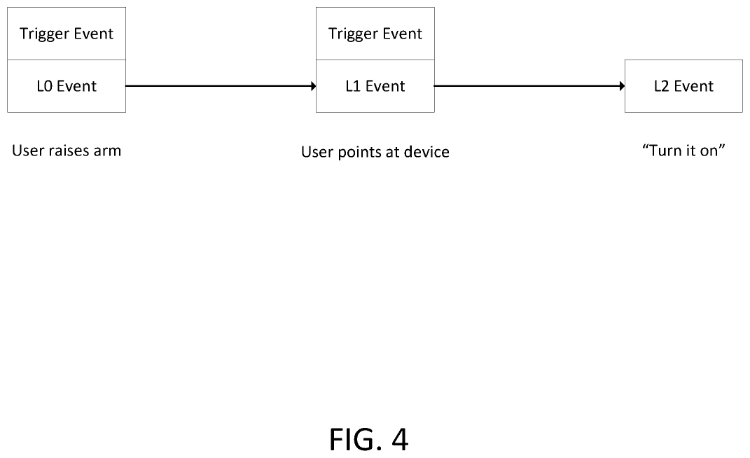

FIG. 4 is an exemplary illustration of a sequence of attention level 0, attention level 1, and attention level 2 events leading to the gesture control system recognizing a gesture and performing an action in response. The user raises their arm indicating an attention level 0 event to trigger the gesture control system to enter attention level 1. The user then points at a device to indicate that an action should be performed on that device. The pointing action triggers the transition to attention level 2. In attention level 2, the user says “turn it on” to indicate the action to be performed on the device. In response, the gesture control system transmits a signal to turn on the target device.

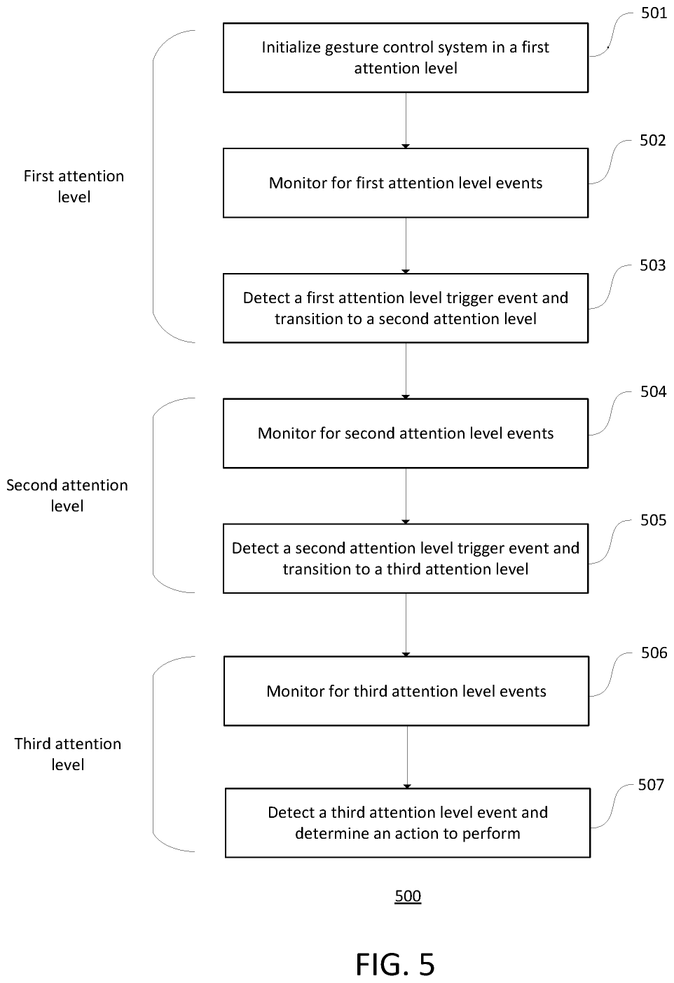

FIG. 5 illustrates an exemplary method 500 that may be performed in some embodiments. In step 501, a gesture control system is initialized in a first attention level. The gesture control system has a second attention level and a third attention level that are distinct from each other and the first attention level. The first attention level has first attention level events, the second attention level has second attention level events, and the third attention level has third attention level events. For example, the first attention level may be attention level 0, the second attention level may be attention level 1, and the third attention level may be attention level 2.

In step 502, while in the first attention level, the gesture control system monitors for first attention level events and ignores second attention level events and third attention level events. In step 503, the gesture control system detects a first attention level trigger event and transitions to a second attention level. In step 504, while in the second attention level, the gesture control system monitors for second attention level events and ignores first attention level events and third attention level events. In step 505, the gesture control system detects a second attention level trigger event and transitions to a third attention level. In step 506, while in the third attention level, the gesture control system monitors for third attention level events and ignores first attention level events and second attention level events. In step 507, the gesture control system detects a third attention level event and determines an action to perform. In some embodiments, the gesture control system determines the action to perform based on the second attention level trigger event and the third attention level event. After determining an action to perform, the gesture control system transmits a signal to an electronic device to perform the action.

In some embodiments, the gesture control system determines from the second attention level trigger event the identity of the electronic device and from the third attention level event the action to perform on the electronic device.

In some embodiments, the second attention level trigger event is a gesture and the third attention level event is a voice command.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

1. A computer-implemented method for detecting gestures in a gesture control system including a plurality of attention levels, the method comprising:
initializing a gesture control system in a first attention level, the gesture control system having a second attention level and a third attention level that are distinct from each other and the first attention level;
wherein the first attention level, second attention level, and third attention level are device states of the gesture control system;
wherein the gesture control system tracks and stores different device states for each of a plurality of users;
the gesture control system being on and monitoring for gesture events with a video camera while in the first attention level;
while in the first attention level, the gesture control system monitoring for first attention level events and not monitoring for second attention level events and third attention level events;
the gesture control system detecting a first attention level trigger event and transitioning to the second attention level;
the gesture control system monitoring for gesture events with a video camera while in the second attention level;
while in the second attention level, the gesture control system monitoring for second attention level events and not monitoring for first attention level events and third attention level events;
while in the second attention level, monitoring for a cancellation gesture configured to transition the gesture control system from the second attention level to the first attention level;
the gesture control system detecting a second attention level trigger event and transitioning to the third attention level;
while in the second attention level, the gesture control system performing body pose estimation on a user to determine gesture information from a user and using the gesture information to detect the second attention level trigger event that causes the transition to the third attention level;
while in the third attention level, the gesture control system monitoring for third attention level events and not monitoring for first attention level events and second attention level events;
the gesture control system detecting a third attention level event and selecting one of a plurality of electronic devices to control based on the second attention level event and determining an action to perform based on the third attention level event and transmitting a signal to the electronic device to perform the action.

2. (canceled)

3. The method of claim 1, wherein each of the first attention level events only indicates a transition from the first attention level to the second attention level and does not encode information about the action to perform

4. (canceled)

5. The method of claim 1, further comprising:
while in the second attention level, setting a second attention level timer to limit the time in the second attention level.

6. The method of claim 1, further comprising:
while in the third attention level, setting a third attention level timer to limit the time in the third attention level.

7. (canceled)

8. (canceled)

9. The method of claim 1, further comprising:
the gesture control system capturing audio data;
while in the third attention level, the gesture control system performing speech recognition to determine a voice command spoken by a user;
the third attention level event comprising the voice command spoken by the user.

10. The method of claim 1, further comprising:
displaying an indication or playing a sound when the gesture control system enters the second attention level.

11. A gesture control system comprising:
a hardware sensor device including a processor and a memory, the memory including instructions for:
initializing the gesture control system in a first attention level, the gesture control system having a second attention level and a third attention level that are distinct from each other and the first attention level;
wherein the first attention level, second attention level, and third attention level are device states of the gesture control system;
wherein the gesture control system tracks and stores different device states for each of a plurality of users;
the gesture control system being on and monitoring for gesture events with a video camera while in the first attention level;
while in the first attention level, the gesture control system monitoring for first attention level events and not monitoring for second attention level events and third attention level events;
the gesture control system detecting a first attention level trigger event and transitioning to the second attention level;
the gesture control system monitoring for gesture events with a video camera while in the second attention level;
while in the second attention level, the gesture control system monitoring for second attention level events and not monitoring for first attention level events and third attention level events;
while in the second attention level, monitoring for a cancellation gesture configured to transition the gesture control system from the second attention level to the first attention level;
the gesture control system detecting a second attention level trigger event and transitioning to the third attention level;
while in the second attention level, the gesture control system performing body pose estimation on a user to determine gesture information from a user and using the gesture information to detect the second attention level trigger event that causes the transition to the third attention level;
while in the third attention level, the gesture control system monitoring for third attention level events and not monitoring for first attention level events and second attention level events;
the gesture control system detecting a third attention level event and selecting one of a plurality of electronic devices to control based on the second attention level event and determining an action to perform based on the third attention level event and transmitting a signal to the electronic device to perform the action.

12. (canceled)

13. The gesture control system of claim 11, wherein each of the first attention level events only indicates a transition from the first attention level to the second attention level and does not encode information about the action to perform

14. (canceled)

15. The gesture control system of claim 11, wherein the memory further comprises instructions for:
while in the second attention level, setting a second attention level timer to limit the time in the second attention level.

16. The gesture control system of claim 11, wherein the memory further comprises instructions for:
while in the third attention level, setting a third attention level timer to limit the time in the third attention level.

17. (canceled)

18. (canceled)

19. The gesture control system of claim 11, wherein the memory further comprises instructions for:
the gesture control system capturing audio data;
while in the third attention level, the gesture control system performing speech recognition to determine a voice command spoken by a user;
the third attention level event comprising the voice command spoken by the user.

20. The gesture control system of claim 11, wherein the memory further comprises instructions for:
displaying an indication or playing a sound when the gesture control system enters the second attention level.
